(19) United States
(12) Patent Application Publication
(10) Pub. No.: US 2003/0036035 A1
(43) Pub. Date: Feb. 20, 2003

(54) Removable analog

(76) Inventor: Cyril Chen, Bergenfield, NJ (US)

Correspondence Address: Donald J. Ersler, 725 Garvens Avenue, Brookfield, WI, 53005, US

(21) Appl. No.: 09/928,829

(22) Filed: Aug. 14, 2001

(51) Int. Cl. A61C 8/00

(52) U.S. Cl. 433/172; 433/173; 433/34

(57) ABSTRACT

A removable analog includes an analog pin having a tapered end and a location boss on the other end. A threaded tap is formed in the other end thereof. At least one flat surface is formed on a length of the analog pin to prevent rotation. At least one groove may also be formed on a length of the analog pin to prevent rotation. A second embodiment of the removable analog includes the analog pin and a sleeve. The sleeve has an internal contour which is sized to slidably receive the analog pin. One end of the sleeve has a tapered end and the other end is sized to receive the analog pin. At least one projection is formed on an exterior surface of the sleeve to prevent removal from a dental model.

### BACKGROUND OF THE INVENTION

1. Field of the Invention

The present invention relates generally to analogs for dental implants and impression copings and more specifically to a removable analog which replaces the necessity for dental model bases, locator pin sets, and nonremovable analogs for dental models.

2. Discussion of the Prior Art

When replicating a cap for a missing tooth, a dental model of the patient's teeth must be generated. An impression tray is filled with an impression paste while an impression coping is attached to the patient's implant. The impression tray is placed over the patient's teeth adjacent the missing tooth. The impression coping is unfastened from the implant when the impression tray is removed. A dental model is generated from the hardened dental model paste in the impression tray. A nonremovable analog is bolted to the impression coping retained in the impression tray. Dental model paste is poured into the impression tray to generate a dental model. After the dental model is generated, it later must be attached to a dental model base with several locator pin sets. The dental model and dental model base must be machined to receive the several locator pin sets. The section with the missing tooth is cut from the dental model. The nonremovable analog remains a part of the missing tooth section and a locator pin set must be attached to the missing tooth section for use in creating the cap.

Accordingly, there is a clearly felt need in the art for a removable analog which eliminates the need for a dental model base, several locator pin sets, nonremoval analog, machining of the dental model base, and machining of the dental model.

### SUMMARY OF THE INVENTION

The present invention provides a removable analog which eliminates the need for several parts and time spent installing them. The removable analog includes an analog pin having a tapered end and a location boss on the other end. A threaded tap is formed in the other end thereof. At least one flat surface is formed on a length of the analog pin to prevent rotation. At least one groove may also be formed on a length of the analog pin to prevent rotation. The cross section of the groove may have any appropriate shape such as semicircular, oval or “V” shaped. A second embodiment of the removable analog includes the analog pin and a sleeve. The sleeve has an internal contour which is sized to slidably receive the analog pin. One end of the sleeve has a tapered end and the other end is sized to receive the analog pin. At least one projection is formed on an exterior surface of the sleeve to prevent removal from a dental model.

The removable analog is preferably installed in the following way. After the impression tray with the impression of the patient's teeth is received, the removable analog is fastened to the impression coping which is already a part of the impression tray. Dental model paste is poured into the impression in the impression tray and left to harden. The removable analog is unfastened from the impression coping and the dental model formed from impression paste is removed from the impression tray. The removable analog may be pulled out of the dental model. The dental model may be used to create a cap. The at least one flat surface and the at least one groove (if used) will prevent the cap model from rotating relative to the dental model. In a second embodiment of the removable analog, the sleeve will remain in the dental model. The analog pin will be withdrawn from the sleeve.

Accordingly, it is an object of the present invention to provide a removable analog which eliminates the need for a dental model base.

It is a further object of the present invention to provide a removable analog which eliminates the need for a several locator pin sets.

Finally, it is another object of the present invention to provide a removable analog which eliminates the need to machine a dental model and dental model base.

These and additional objects, advantages, features and benefits of the present invention will become apparent from the following specification.

### BRIEF DESCRIPTION OF THE DRAWINGS

FIG. 1 is a cross sectional view of a prior art method of replicating a cap from a dental model formed from an impression tray.

FIG. 2 is a side view of a prior art dental model and dental model base for replicating a cap formed from an impression tray.

FIG. 3 is a cross sectional view of a removable analog in a dental model formed from an impression tray in accordance with the present invention.

FIG. 3a is a cross sectional view of a removable analog removed from a dental model in accordance with the present invention.

FIG. 4 is a cross sectional view of a second embodiment of a removable analog in a dental model formed from an impression tray in accordance with the present invention.

FIG. 4a is a cross sectional view of an analog pin removed from a sleeve in a dental model in accordance with the present invention.

FIG. 5 is a first end view of a removable analog in accordance with the present invention.

FIG. 6 is a side view of a removable analog in accordance with the present invention.

FIG. 7 is a second end view of a removable analog in accordance with the present invention.

FIG. 8 is a top view of a removable analog in accordance with the present invention.

FIG. 9 is a bottom view of a removable analog in accordance with the present invention.

FIG. 10 is a first end view of a sleeve of a second embodiment of a removable analog in accordance with the present invention.

FIG. 11 is a side view of a sleeve of a second embodiment of a removable analog in accordance with the present invention.

FIG. 12 is a second end view of a sleeve of a second embodiment of a removable analog in accordance with the present invention.

### DETAILED DESCRIPTION OF THE PREFERRED EMBODIMENTS

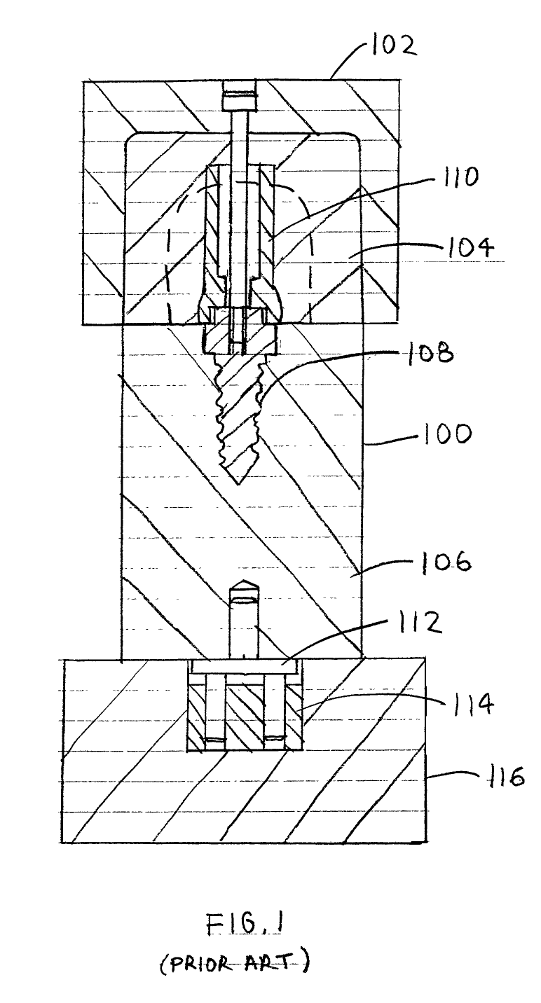

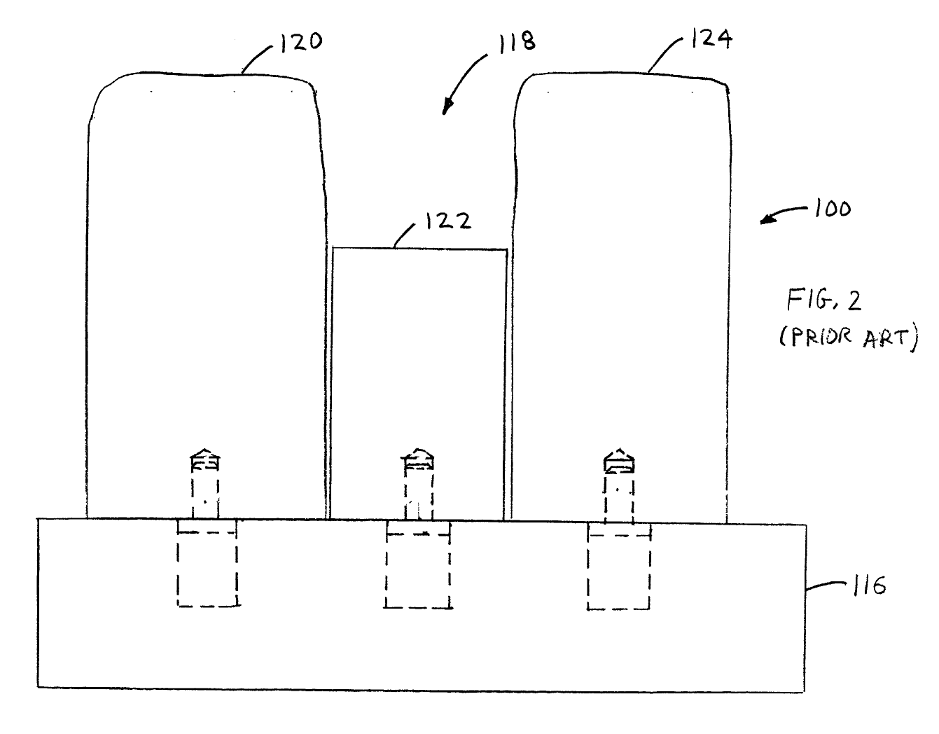

With reference now to the drawings, and particularly to FIG. 1, there is shown a cross sectional view of a prior art method of method of replicating a cap from a dental model 100 formed from an impression tray 102. After the impression paste 104 in the impression tray 102 hardens, dental model paste 106 is poured into the hardened impression paste 104 in the impression tray 102. Most of the dental model paste 106 is left outside the dental tray 102 for handling purposes. A nonremovable analog 108 is fastened to an impression coping 110 which is captured in the hardened impression paste 104. After the dental model paste 106 hardens into a dental model 100, the nonremovable analog 108 is unfastened from the impression coping 110. The bottom of the dental model 100 is machined flat. Holes are formed in the bottom of the dental model 100 to receive several locator pins 112 and several holes are formed in a top of a dental base 116 to receive several locator bushings 114. With reference to FIG. 2, the dental model 100 is sawed on either side of the toothless area 118 to form a first dental section 120, a toothless section 122, and a second dental section 124. The toothless section 122 is removed. The first dental section 120, second dental section 124, and dental model base 116 are used to create a cap.

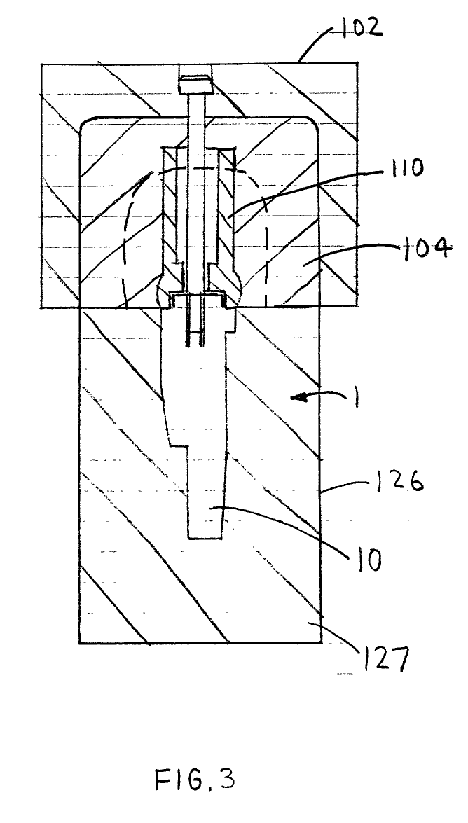

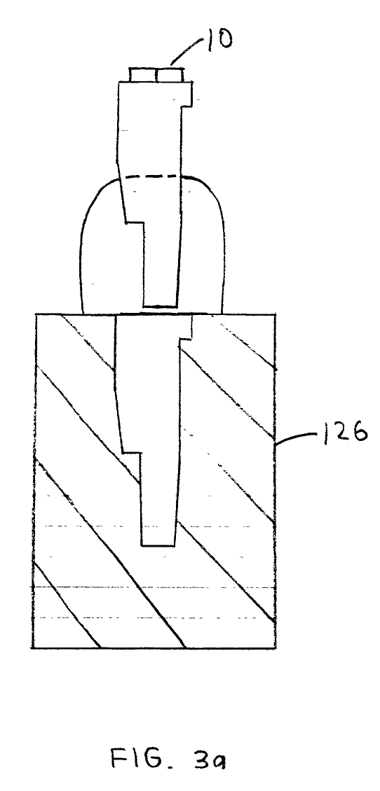

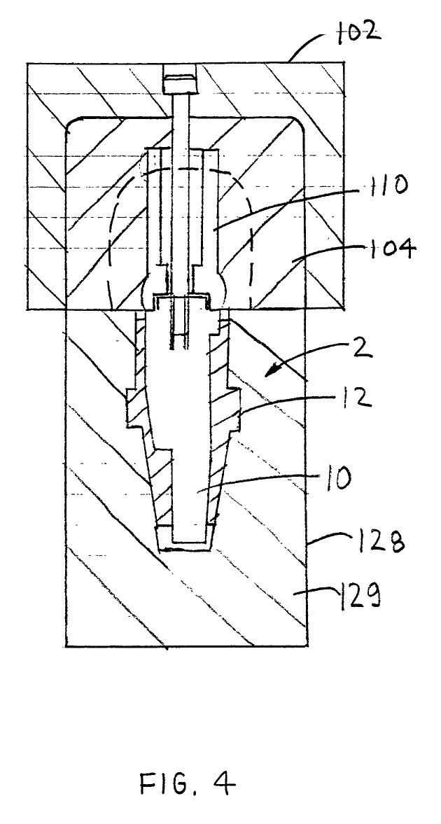

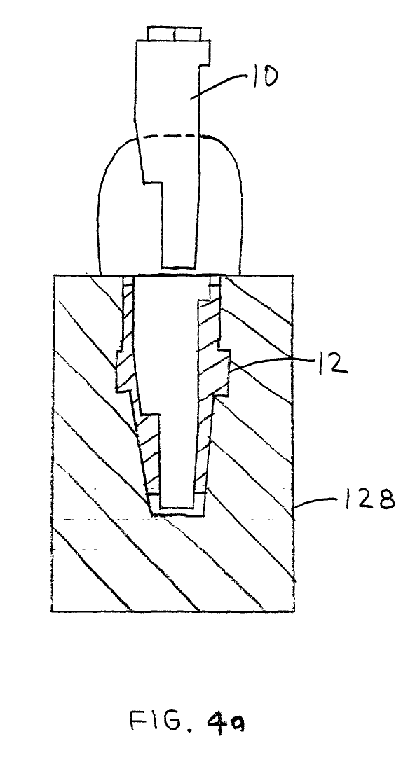

FIG. 3 shows a cross sectional view of an analog pin 10 in a dental model 126 formed from an impression tray 102. FIG. 3a shows the analog pin 10 unfastened from the impression coping 110 in the impression tray 102 and removed from the dental model 126 after the dental model paste 127 hardens. FIG. 4 shows a cross sectional view of a second embodiment of a removable analog 2 in a dental model 128 formed from an impression tray 102. The removable analog 2 includes the analog pin 10 and a sleeve 12. FIG. 4a shows the analog pin 10 unfastened from the impression coping 110 in the impression tray 102 and withdrawn from the sleeve 12 in the dental model 128 after the dental model paste 129 hardens. The sleeve 12 is permanently retained in the dental model 128 when the dental paste 129 hardens.

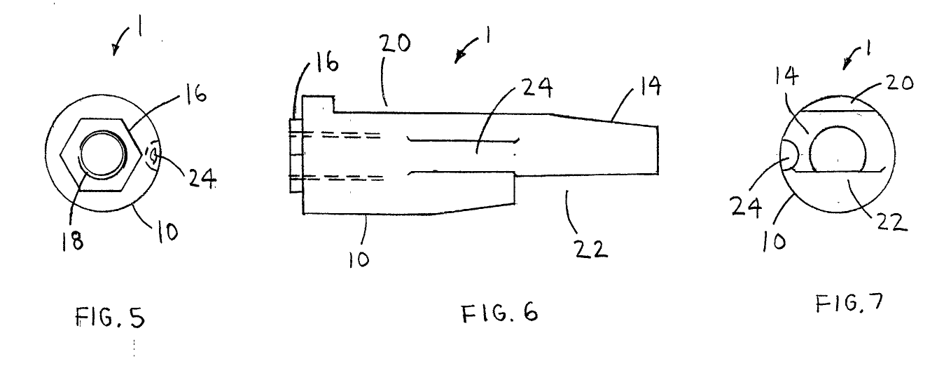

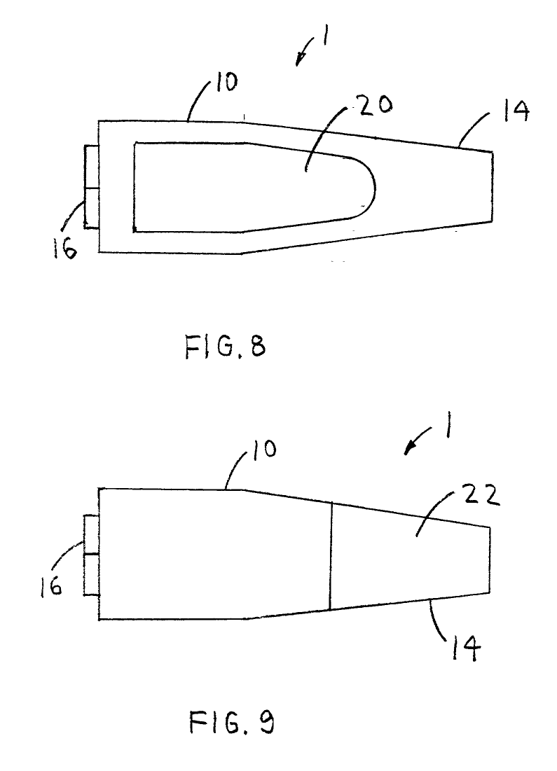

With reference to FIGS. 5-9, the removable analog 1 includes an analog pin 10 having a tapered end 14 and a location boss 16 on the other end. The location boss 16 mates with a boss cavity in an impression coping. A threaded tap 18 is formed in the other end thereof. At least one flat surface is formed on a length of the analog pin 10 to prevent rotation. Preferably, a first flat surface 20 is formed on one side of the analog pin 10 and a second flat surface 22 is formed on the other side thereof. Optionally, at least one groove 24 may also be formed on a length of the analog pin 10 to prevent rotation. The cross section of the groove 24 may have any appropriate shape such as semi-circular, oval or “V”-shaped. A semi-circular cross-section is shown in FIGS. 5-7.

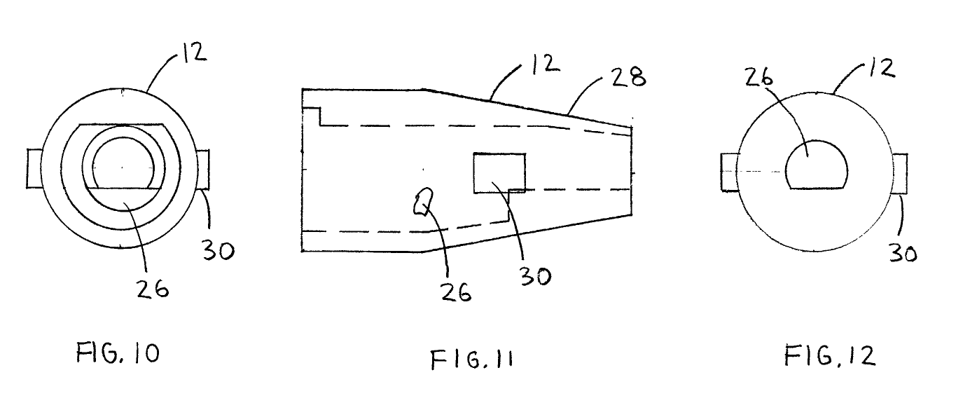

With reference to FIGS. 10-12, a second embodiment of the removable analog 2 includes the analog pin 10 and the sleeve 12. The sleeve 12 has an internal contour 26 which is sized to slidably receive the analog pin 1, including the at least one flat surface. One end of the sleeve 12 preferably has a tapered end 28 and the other end is receives the analog pin 10. At least one projection 30 is formed on an exterior surface of the sleeve 12 to prevent removal from a dental model. The at least one projection 30 may be any appropriate shape. The sleeve 12 is preferably fabricated from a molded plastic.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

I claim:

1. A removable analog comprising:
an analog pin having a tapered end and a location boss formed on the other end, a threaded tap being formed in the other end; and
at least one flat surface being formed on a length of said analog pin.

2. The removable analog of claim 1 wherein:
a groove being formed on a length of said analog pin.

3. The removable analog of claim 1, further comprising:
a sleeve having an internal contour which is sized to slidably receive said analog pin, said internal contour including at least one flat surface and a tapered surface, at least one projection being formed on an exterior surface of said sleeve.

4. The removable analog of claim 1, further comprising:
said sleeve including a tapered end adjacent said tapered surface formed inside said internal contour.

5. A method of creating a dental model with a removable analog comprising the steps of:
(a) attaching a removable analog to an impression tray, said removable analog having a tapered end;
(b) inserting dental model paste into said impression tray to form a dental model, said dental model paste encapsulating at least a portion of said removable analog; and
(c) withdrawing said removable analog from said dental model.

6. The method of creating a dental model with a removable analog of claim 5 wherein:
at least one flat surface being formed on a length of said removable analog.

7. The method of creating a dental model with a removable analog of claim 5 wherein:
at least one groove being formed on a length of said removable analog.

8. The method of creating a dental model with a removable analog of claim 5, further comprising:
an impression coping being molded into said impression tray for attachment of said removable analog thereto.

9. A method of creating a dental model with a removable analog comprising the steps of:
(a) attaching an analog pin to an impression tray, said removable analog including said analog pin and a sleeve, said analog pin having a tapered end;
(b) inserting dental model paste into said impression tray to form a dental model, said dental model paste encapsulating at least a portion of said sleeve; and
(c) withdrawing said analog pin from said sleeve.

10. The method of creating a dental model with a removable analog of claim 9 wherein:
said sleeve having at least one projection formed on an exterior surface thereof.

11. The method of creating a dental model with a removable analog of claim 9 wherein:
at least one flat surface being formed on a length of said removable analog.

12. The method of creating a dental model with a removable analog of claim 9, further comprising:
an impression coping being molded into said impression tray for attachment of said removable analog
